(19) United States
(12) Patent Application Publication
(10) Pub. No.: US 2011/0231548 A1
(43) Pub. Date: Sep. 22, 2011

(54) Systems and Methods for Mediating the Delivery of Internet Service to At Least One User Device Coupled to the Internet Service

(76) Inventor: Tom C. Tovar, San Francisco, CA (US)

(21) Appl. No.: 12/897,303

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 15/16

(52) U.S. Cl. 709/225

(57) ABSTRACT

Systems and methods for mediating the delivery of Internet service to at least one user device coupled to the Internet service are provided herein. A method for mediating the delivery of Internet service to at least one user device coupled to the Internet service includes executing instructions stored in memory by a processor to prevent the delivery of Internet service to the at least one user device for a predetermined period of time after an occurrence of a triggering event.

### CROSS-REFERENCE TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

The present invention relates generally to mediating the delivery of Internet service to at least one user device coupled to the Internet service, and more specifically, but not by way of limitation, to systems and methods for preventing the delivery of the Internet service to the at least one user device for a predetermined period of time after the occurrence of a triggering event.

### SUMMARY OF THE INVENTION

According to exemplary embodiments, the present invention provides a method for mediating the delivery of Internet service to at least one user device coupled to the Internet service. The method may include executing instructions stored in a memory by a processor to prevent the delivery of Internet service to the at least one user device for a predetermined period of time after an occurrence of a triggering event.

According to other exemplary embodiments, the present invention provides a system for mediating the delivery of Internet service to at least one user device coupled to the Internet service. The system may include a memory for storing a program, a processor for executing the program, (a) a conduct policy module stored in the memory and executable by the processor to receive information indicative at least one of: (i) administrator-defined Internet content; (ii) at least one category of restricted Internet content; and (iii) an administrator-defined period of time; and (b) a policy application engine stored in the memory and executable by the processor to apply a conduct policy to the Internet service to prevent the delivery of the Internet service to at least one user device coupled to the Internet service for a predetermined period of time after the occurrence of a triggering event, wherein the triggering event includes an attempt to access restricted Internet content received from a user device coupled to the Internet service and wherein the conduct policy includes Internet content corresponding to the information received by the conduct policy module.

According to additional exemplary embodiments, the present invention provides a computer readable storage medium having a program embodied thereon. The program is executable by a processor in a computing device to perform a method of mediating Internet service delivered to at least one user device coupled to the Internet service. The method may include executing instructions stored in a memory by a processor to prevent the delivery of Internet service to the at least one user device for a predetermined period of time after an occurrence of a triggering event.

### BRIEF DESCRIPTION OF THE DRAWINGS

FIG. 1 is a block diagram of an exemplary architecture for practicing embodiments of the present technology that includes a compliance policy application.

FIG. 2 is a flowchart of an exemplary method for mediating Internet service delivered to at least one user device.

FIG. 3 is an exemplary user interface in the form of a web page describing how an administrator may subscribe to the compliance policy application.

FIG. 4 is an exemplary user interface in the form of a web page utilized by an administrator to create a conduct policy.

FIG. 5 is an exemplary user interface in the form of a blocking web page that is displayed when an end user attempts to access an inappropriate Internet content.

FIG. 6 is a schematic diagram of a DNS server arrangement.

FIG. 7 is a schematic of an exemplary system for providing variable content control for Internet users.

FIG. 8 illustrates an exemplary computing device that may be used to implement an embodiment of the present technology.

### DETAILED DESCRIPTION OF EXEMPLARY EMBODIMENTS

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated. According to exemplary embodiments, the present technology relates generally to mediating the delivery of Internet service to at least one user device coupled to the Internet service. More specifically, systems and methods are provided to prevent the delivery of the Internet service to the at least one user device for a period of time after the occurrence of a triggering event.

Generally speaking, the systems and methods are provided to create and enforce Internet conduct policies for end users. These conduct policies are enforced by terminating access to the Internet for a predetermined period of time when an end user violates the conduct policy.

As background, a plurality of end users may utilize a variety of user devices to access an Internet service at a given location. Commonly, the plurality of end users includes one or more parents and one or more children. A parent (or other guardian) often wishes to limit children's access to particular Internet content or categories of Internet content. For example, a parent may feel uncomfortable with their child accessing pornographic Internet content or a particular social networking domain. Therefore, many parents establish verbal Internet policies that provide guidance to their children regarding acceptable Internet conduct.

Unfortunately, clearly established rules stated by parents regarding Internet activities of the end users are sometimes ignored and the parent may be unable to monitor the Internet activities of their children frequently enough to catch the child breaking the rules. Moreover, monitoring compliance with these established rules often involves locating and reviewing the Internet history of every user device accessing the Internet service, which can be both a time consuming and overwhelming task for parents. To further complicate matters, computer savvy children may be able to remove evidence of rules violations by deleting Internet history such as browser cache, cookies, and/or other logs of Internet activity.

Even if the parent is able to determine that an end user has accessed restricted Internet content, the only recourse available to the parent is denying access to the user device. It will be understood that because a location may have a plurality of user devices capable of accessing the Internet service, preventing end users from accessing the Internet service requires sequestering every user device in the residence. Moreover, as accessing an Internet service is only one of many functions for most user devices, sequestering a user device prevents the end user from employing the user device in other legitimate ways, such as word processing, gaming, and the like.

Therefore, exemplary embodiments of the present technology allow parents, hereinafter referred to as “administrator,” to create, modify, and/or apply conduct policies that may prevent the delivery of Internet service by to at least one user device. The conduct policies may be created utilizing a compliance policy application accessible via a user interface. It will be understood that the conduct policies are a digital embodiment of the Internet conduct rules established between the parent and child, and the compliance policy application may be capable of ensuring compliance with the conduct policy. As such, the compliance policy application enforces the established rules (e.g., conduct policy) by preventing the delivery of the Internet service to a user device for a predetermined period of time after a violation of the Internet conduct policy.

The term “administrator” may include not only individuals, such as parents, but also any individual creating conduct policies regarding the Internet activities of end users. It will be understood that an administrator may also be an end user, although end users who are not also administrators may not create or apply conduct policies.

As the compliance policy application applies the conduct policy to the Internet service rather than affecting the operations of the user device itself, the compliance policy application may mediate the Internet service delivered to each user device that accesses the Internet service. Although, in various exemplary embodiments, a compliance policy application (or portions thereof) may also reside and operate on one or more of the user devices.

Additionally, because many end users may access the Internet service and the conduct policy is applied to the Internet service, the compliance policy application enforces a “shared consequence” between all end users equally. Therefore, end users who have not attempted to access restricted Internet content are prevented from accessing the Internet service for the predetermined period of time. As such, the compliance policy application leverages the power of peer-pressure to create an incentive for end users having a tendency to access restricted domains. An end user may modify their Internet activities to prevent loss of access to the Internet service for the other end users. Stated otherwise, the compliance policy application helps teach and enforce responsible Internet conduct without the need for constant parental supervision.

Generally speaking, an administrator may create and enforce mediation polices for one or more end users that utilize computing devices coupled to an Internet service delivered to a location such as a home, residence or place of business or campus. The term “administrator” may include not only individuals, such as parents, but also any individual creating a mediation policies regarding the Internet service delivered to end users. It will be understood that an administrator may also be an end user, although end users who are not also administrators may not create or apply policies.

It will be further understood that because of the diversity of computing devices that may connect to the Internet service, the policy may be applied to the Internet service rather than requiring the policy to affect each computing device individually, such as a mediation application resident on each computing device. In various exemplary embodiments a policy may also reside as a stand alone application on one or more of the computing devices.

Exemplary user devices for use with the disclosed systems may have a user interface. In various embodiments, such as those deployed on personal mobile devices, the user interface may be, or may execute, an application, such as a mobile application (hereinafter referred to as an “app”). An app may be downloaded and installed on a user's mobile device. Users may define a mediation policy via a user device, such as through the user interface. Some embodiments of the present invention do not require software to be downloaded or installed locally to the user device and, correspondently, do not require the user to execute a de-install application to cease use of the system.

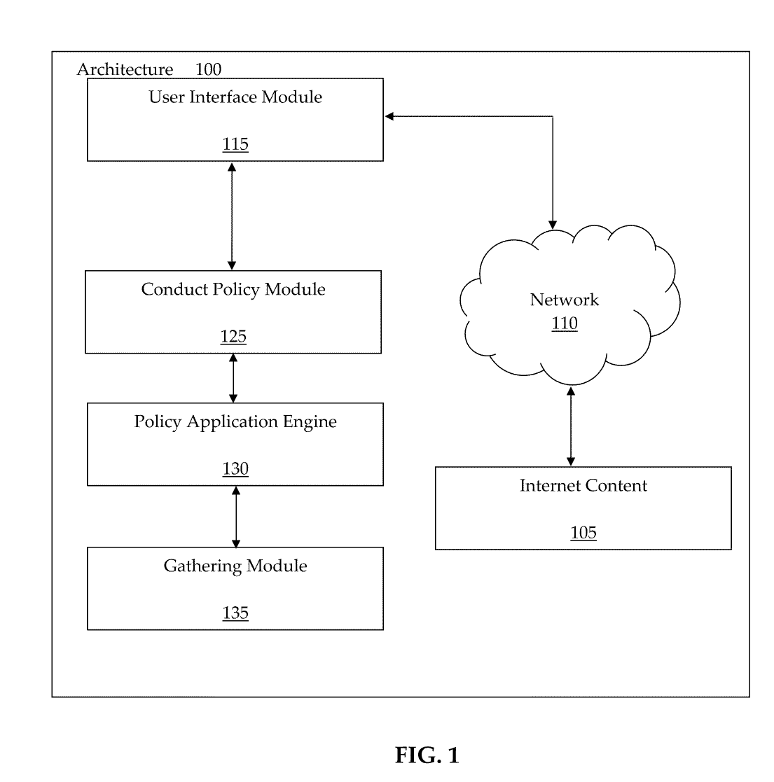

Referring now to FIG. 1, an exemplary architecture 100 of an exemplary conduct policy application. The computing device 105 may access Internet content 105 via network 110 utilizing user interfaces generated by the user interface module 115. It will be understood that the compliance policy applications may reside on a user device that does not couple to the Internet service such as a user device located remotely. It will also be understood that the compliance policy application may reside on a DNS server 610.

Generally speaking, the compliance policy application allows an administrator to create and enforce one or more conduct policies regarding the Internet activities of end users. A conduct policy, when applied to the Internet service prevents the delivery of the Internet content to at least one user device for a predetermined period of time after the occurrence of a triggering event. It is important to note that the compliance policy application does not simply prevent the delivery of Internet content by masking or enabling network controls, but rather mediates Internet service provided to one or more end users. As used herein, mediating the Internet service may include any of blocking, constraining, enabling, redirecting, obscuring, limiting, interrupting, and restricting the Internet content delivered to a user device coupled to the Internet service.

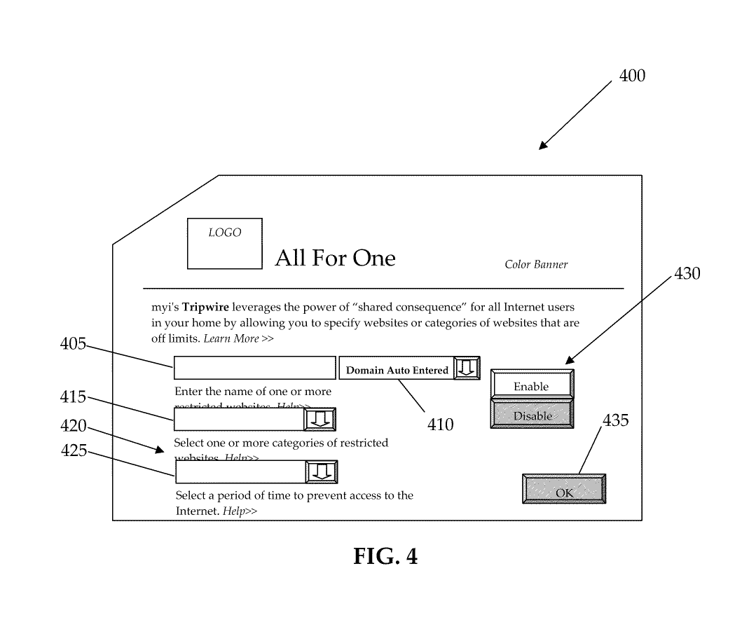

The compliance policy application allows for the creation of conduct polices via a user interface that may be generated by a user interface module 115. The user interface may be implemented in many embodiments, although in various exemplary implementations, the user interface includes a web page adapted to receive conduct policy information from an administrator, as illustrated in FIG. 4.

According to exemplary embodiments, the compliance policy application may include a conduct policy module 125, a policy application engine 130, and an optional gathering module 135. It is noteworthy that the compliance policy application may be composed of more or fewer modules and engines (or combinations of the same) and still fall within the scope of the present technology. Furthermore, the functionalities of one or more of the modules and engines may be combined.

In general, the conduct polices created by the conduct policy module 125 may be applied to the Internet service. According to exemplary embodiments, the Internet service may be defined as an Internet service delivered by an Internet service provider through a DNS server. The conduct policy module 125 creates a conduct policy by first receiving information indicative of at least one of (i) administrator-defined Internet content and (ii) at least one category of restricted Internet content, from the administrator.

As stated previously, the administrator inputs the information via the user interface displayed on a first user device. In greater detail, the administrator may request that all Internet content 105 within a particular category of Internet content 105 be restricted for the end users. For example, the administrator may want to deny access to all social networking Internet content 105. Therefore, the administrator may input information indicative of a category of restricted Internet content such as “social networking.” The conduct policy module 125 may then locate Internet content 105 that has been categorized as “social networking” and add the located Internet content 105 to the conduct policy. The conduct policy module 125 may locate Internet content 105 by searching one or more Internet content records that contain Internet content that has been evaluated and categorized according to their content.

Internet content records may be populated by execution of the gathering module 135. The gathering module 135 locates Internet content 105 by way of web crawling or spidering the Internet for Internet content 105. The Internet content 105 located by the gathering module 135 is evaluated for content by the conduct policy module 125 and categorized into Internet content records that may reside in the database. The Internet content records may be categorized according to content such as social networking, news, sports, etc. It will be understood that systems and methods for gathering or locating Internet content 105 (such as web crawling or spidering) are beyond the scope of this application, but would be readily understood and applied to the present disclosure by one of ordinary skill in the art.

In various embodiments, the gathering module 135 may automatically and continuously, or periodically, locate additional Internet content 105 so that the Internet content records may continually evolve/grow over time.

Additionally, the administrator may be allowed to input administrator-defined Internet content as a way of customizing the conduct policy for the end users. It will be understood that value systems may vary widely between groups of end users. Therefore, the administrator may establish a conduct policy that is unique for their particular end users. Moreover, the administrator may edit or modify the conduct policies so that the conduct policies may evolve over time in response to the ever-changing needs of the end users. Stated otherwise, the compliance policy application is flexible, adaptable, and functions as a rule enforcement proxy when the administrator is not present. New groups of conduct polices may also be socially produced by groups of unaffiliated administrators.

According to exemplary embodiments, the administrator may wish to limit access to particular Internet content such as domains. As such, the conduct policy module 125 may receive information indicative of administrator-defined from the administrator via the user interface. For example, the administrator may enter the input indicative of a domain such as a domain name of a website (e.g., “www.restrictedsite.com”) if known. Additionally, the administrator may enter only the generic name of the website (e.g., “Restricted Site” or “The Restricted Site”), wherein the name may include the name of a business or a location. If the administrator enters a name of administrator-defined domain, the conduct policy module 125 may evaluate the name to determine if there are one or more domains that correspond to the name. If there is only one domain that corresponds to the name, the conduct policy module 125 may automatically include the evaluated domain in the conduct policy. In contrast, if the conduct policy module 125 locates two or more domains corresponding to the name, the conduct policy module 125 may cause the user interface module 115 to display one or more selections on a web page representing the located domain names. The administrator may then choose one or more of the selections displayed by the user interface module 115. The chosen domain(s) are then included in the conduct policy.

Additionally, the administrator may select a predetermined period of time for preventing delivery of the Internet service, after an occurrence of a triggering event. The administrator may select, for example, time periods in increments of hours or an indefinite amount of time that ends at the request of the administrator. It will be understood that if the administrator does not select an administrator-defined period of time, the conduct policy module 125 may select a default period of time equal to one hour.

The conduct policy module 125 combines the categories of restricted Internet content with the administrator-defined Internet content and a predetermined period of time to create a conduct policy that is unique for the end users. The conduct policy may be stored as a user record that resides in the database. It will be understood that the database may include one or more databases, which may reside on at least one of the computing devices, the DNS server 610, and the cloud network 615.

The conduct policy may then be applied to the Internet service to prevent the delivery of the Internet service. According to exemplary embodiments, the policy application engine 130 evaluates requests for Internet content 105 received from a user device and prevents the delivery of the Internet service to the user device for a predetermined period of time after an occurrence of a triggering event. According to the present disclosure, a triggering event may be defined as an attempt to access restricted Internet content received from a user device coupled to the Internet service.

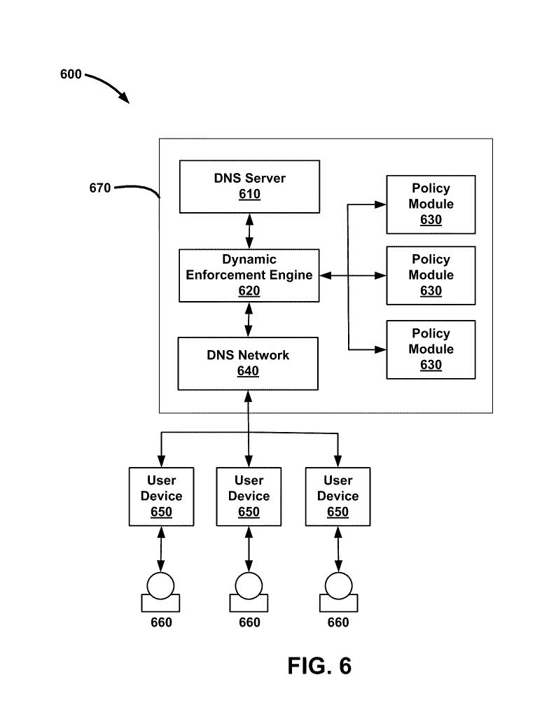

More specifically, after occurrence of a triggering event, the Internet service performs at least one of the following actions: (1) prevent the Internet service (FIG. 6) from resolving Internet content before the Internet service reaches the displays of the user devices for a predetermined period of time; (2) prevent the Internet service provider from resolving Internet content before the Internet service reaches the displays of the user devices for a predetermined period of time; or (3) terminate delivery of the Internet service to the Internet connection device for a predetermined period of time. In the first case, the Internet service may not resolving the Internet content 105 by affecting commands and actions occurring on the Internet service.

The administrator, via utilization of the user interface, may terminate application of the conduct policy to the Internet service at any time. The user interface may include a button (such as an enable/disable button 420 of exemplary FIG. 4) or a check box that may be toggled by the administrator to enable/disable the application of the conduct policy to the Internet service.

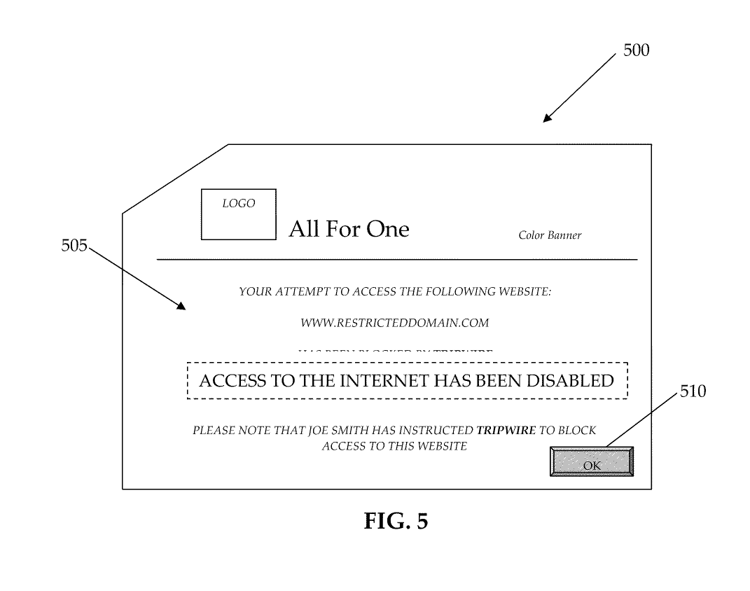

Additionally, for the predetermined period of time after a triggering event, the policy application engine 130 may cause the user interface module 115 to generate a user interface that includes a blocking message when a user device coupled to the Internet service attempts to access the Internet service. According to various embodiments, the user interface may include a web page notifying the end user that access to the Internet service has been prevented by the compliance policy application. An exemplary blocking page is shown in FIG. 5.

According to other embodiments, the database may be employed by the conduct policy module 125 to record and to notify administrators of various data relative to Internet access. The data collected from and provided to the administrators may include records of specific instances of triggering events. Additionally, the conduct policy module 125 may record an aggregate number of triggering events occurring within a given period of time. The data collected may be organized into logs that may be stored in a user record and accessed by the user interface module 115. More specifically, the user interface module 115 may generate a web page (not shown) including log data indicative of the triggering event including the name of the restricted Internet content 105 that caused the triggering event.

According to the present disclosure, the compliance policy application may prevent the delivery of Internet service to all user devices coupled to the Internet service. For example, a conduct policy may be created utilizing a first user device (not shown) such as a desktop computer operated by an administrator. The delivery of Internet service to additional user devices (also not shown) continues uninterrupted until the occurrence of a triggering event. It will be understood that the first user device and the second user device may be the same.

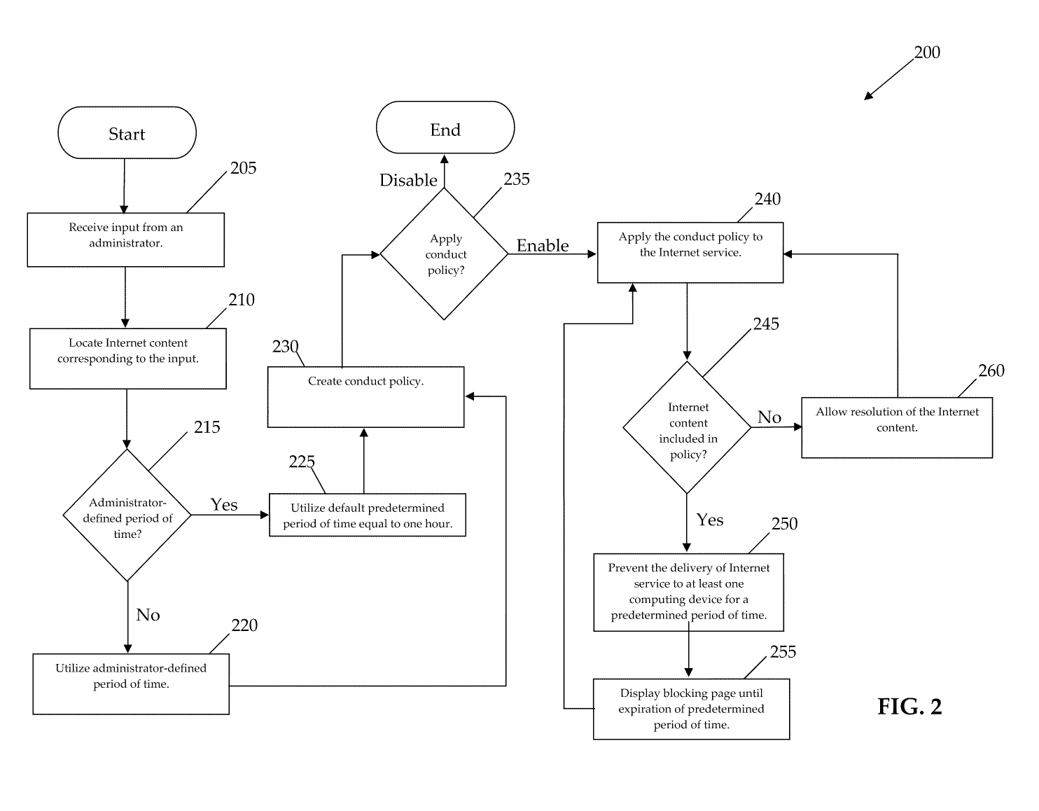

Referring now to FIG. 2, a method 200 for mediating Internet service provided to at least one user device coupled to the Internet service begins with a step 205 of an administrator inputting information that may be utilized to create a conduct policy. For example, a user interface is provided to an administrator via a user device. The user interface may display a variety of input fields to the administrator. One or more messages may be displayed on the user interface to elicit input from the administrator. The user interface may then receive information indicative of at least one of: (i) administrator-defined Internet content; (ii) at least one category of restricted Internet content; and (iii) an administrator-defined period of time. According to various embodiments, receiving the above-described types of information may be performed by the Internet service via a user interface.

Information received by the user interface may be utilized by the conduct policy module to create a conduct policy. For example, the administrator inputs information indicative administrator-defined Internet content such as the name of a restricted domain “Restricted Site.” Additionally, the administrator selects a category, for example, “social networking” Internet content. Finally, the administrator selects an administrator-defined time period equal to two hours.

In step 210, the conduct policy module locates Internet content corresponding to the name “Restricted Site” and displays the located Internet content as selections via a web page generated by the user interface. The administrator may choose one or more of the selections to add to the conduct policy.

Also in step 210, the conduct policy module locates information indicative of social networking Internet content by searching one or more Internet content records for Internet content that has been evaluated and categorized as “social networking.”

In step 215, the conduct policy module determines a predetermined period of time to prevent delivery of the Internet service by utilizing either the administrator-defined period of time received in step 205 or a default period of time that may equal one hour. If the administrator selected an administrator-defined period of time the conduct policy module utilizes the administrator-defined period of time, in step 220. Conversely, if the administrator did not selected an administrator-defined period of time the conduct policy module utilizes the default period of time in step 225.

In a step 230, the conduct policy module may combine the received information together to create a conduct policy. Once created, the conduct policy may be stored in a database until the administrator modifies, removes, or replaces the conduct policy.

In an additional step 235, the administrator may enable/disable the application of the conduct policy to the Internet service. The administrator may enable/disable the application of the conduct policy via a button located on a user interface (such as the enable/disable button 420 of exemplary FIG. 4). If the administrator does not enable the conduct policy, the method terminates.

If the administrator enables application of the conduct policy, the method 200 further includes a step 240 of receiving a request to access Internet content, wherein the requests are received from at least one user device. More specifically, each application of the conduct policy begins with an end user inputting a request to access Internet content on a user device. The end user may input this request via a browser operating on the user device. In various embodiments, a request includes clicking a hyperlink located on a web page. It will be understood that the request may include a domain name corresponding to requested Internet content.

In an additional step 245, the policy application engine receives the request and compares the request against the conduct policy. A triggering event occurs when the policy application engine determines that requested Internet content is included in the conduct policy. Upon occurrence of a triggering event, the policy application engine causes the dynamic enforcement engine to prevent the Internet service from resolving Internet content in step 250 by affecting the commands and operations of the Internet service. In addition to immediately blocking resolution of the restricted Internet content, the enforcement engine prevents the delivery of the Internet service to the at least one user device for the predetermined period of time.

In addition to preventing delivery of the Internet service, the policy application engine may, in step 255, display a notification message to the end user in the form of a blocking web page. It will be understood that the user interface module may generate the blocking web page. The blocking web page may include the following content: a message that the attempt to access the requested Internet content has been denied; a message that access to the Internet service has been prevented; a message that the attempt was blocked by the compliance policy application (which may include the trade name of the application); a message that the administrator has established that the requested Internet content be blocked; and/or any combinations thereof. It will be understood that messages regarding the triggering event or an amount of time left before the predetermined period of time elapses may not be presented to the end user to facilitate communication between the administrator and the end user.

It will further be understood that upon the expiration of the predetermined period of time, the method returns to step 240 to evaluate additional requested Internet content.

In contrast, if the policy application engine determines that the requested Internet content is not included in the conduct policy, a step 260 allows the dynamic enforcement engine to cause the Internet service to resolve the Internet content. The Internet content is then provided by the Internet service to the end user via the user device. It will be understood that after causing the Internet service to resolve the Internet content, the method returns to step 240 to evaluate additional requested Internet content.

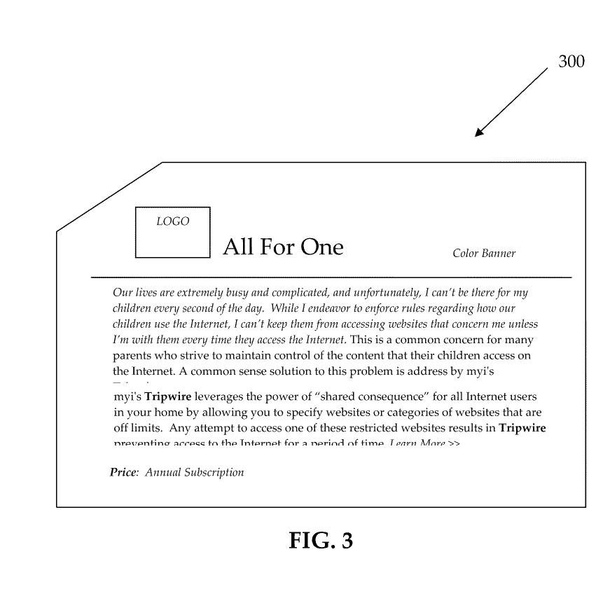

FIG. 3 illustrates an exemplary web page 300 for subscribing to the compliance policy application. The web page may include (i) content describing the functionality of the application; (ii) the name of the application; (iii) a link to a more detailed information; and (iv) a price description.

FIG. 4 illustrates an exemplary user interface, which in this instance includes a web page 400 having a first text input box 405 for receiving information indicative of administrator-defined Internet content. It will be understood that, rather than a first text input box 405, the user interface 400 may include any number of items utilized to receive input indicative of administrator-defined Internet content. The compliance policy application locates Internet content corresponding to the input and displays the located Internet content as selections on the web page 400. If the compliance policy application locates an incorrect Internet content in response to an administrator input, a drop-down menu 410 located adjacent to the first text input box 405 includes additional selections of other possible Internet content located by the compliance policy application.

The user interface also includes a drop-down menu 415 for displaying a selection of a plurality of categories of restricted Internet content such as sports, news, financial, political, educational, social networking, health, pornographic, and gaming. The administrator may choose one or more of the selections. Each of the text input box 405 and drop-down menu 415 may include instructions 420 that elicit input from the administrator. The instructions 420 may be located proximate an appropriate input component. The web page 400 may also include a drop-down menu 425 for selecting an administrator-defined period of time.

An enable/disable button(s) 430 is included, allowing an administrator to selectively control the application of the conduct policy by enabling/disabling the functionality of the compliance policy application. Once the administrator is finished inputting information and enabling/disabling application of the conduct policy, the administrator may utilize button 435 to close the web page 400.

FIG. 5 illustrates an exemplary user interface 500, which in this instance includes a blocking web page having content that includes message in the form of a text block 505. The text block 505 includes a message that the attempt to access the requested Internet content has been denied and that access to the Internet service has been prevented. The text block 505 also includes a message that the attempt was blocked by the compliance policy application herein described as “Tripwire”. Lastly, the text block 505 includes a message that an administrator requested that the Internet content be blocked. Additionally, an end user may utilize button 510 to close the user interface 500.

FIG. 6 illustrates an exemplary Internet service system 600, with a DNS server 610, that may be utilized to support the above described systems and methods. The DNS server 610 operates in conjunction with a dynamic enforcement engine 620. The dynamic enforcement engine 620 may operate in conjunction with one or more policy modules 630 to establish any applicable polices at the DNS level. The content rules are applied to received user queries, and determine the content that is delivered by the DNS network 640 through various user devices 650 to the end users 660.

The dynamic enforcement engine 620 may generate its policy engine on instructions received from one or more policy modules 630. Each policy module 630 may be constructed to provide various types and levels of services to the DNS network 640. In various embodiments, a policy module 630 may be configured to handle queries directed to subjects including, but not limited to, malicious domain redirection, user access redirection, non-existent domain redirection, and data collection or analysis.

It will be recognized by those skilled in the art that the elements of DNS service 670 may be hosted either locally or remotely. In addition to residing in the DNS service 670, one or more of the DNS network 640, the dynamic enforcement engine 620, and the policy modules 630, and any combination thereof, may be resident on one or more user devices 650.

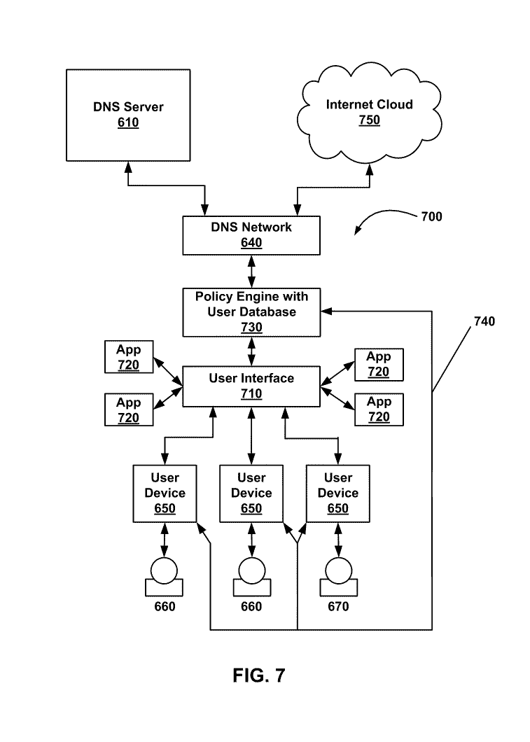

FIG. 7 shows a schematic layout of an exemplary system 700 for implementing direct and variable end user control. FIG. 7 illustrates that the system 700 may operate installed on a DNS server 610, or with a cloud 750 based installation.

The system 700 utilizes a user interface 710. The user interface 710 may be implemented in many embodiments. One specific implementation of the user interface 710 is as a web page.

According to exemplary embodiments, the system 700 may also include an Internet connection device (not shown) connecting the user devices to the Internet service. Common examples of Internet connection devices include cable or DSL modems. It will be understood that the Internet connection device serves as a hub that provides the Internet service from the DNS server 610 (FIG. 6) via the DNS network 640 to all user devices coupled thereto.

The user interface 710 may be accessed by one or more user devices 650 operated by the users 660. The user interface 710 may be accessed though a gateway user device 650 available to the users 660. Suitable user devices 650 include but are not limited to desktops, PCs, laptops, notebooks, gaming devices, tablets, music players, Smartphones, automobile computer systems, and Internet enabled TVs. The system 700 may also be deployed, accessed or controlled remotely controlled via user devices 650, such as a Smartphone or other Internet mobile access device. A Smartphone may be defined as a phone with computing capability. A Smartphone may provide the user 660 with Internet access.

The user interface 710 provides a mechanism for one or more authorized users 660 to establish content policy for the Internet service. The user interface 710 operates between the user devices 650 present in the system 700 and the DNS network 640. Instructions resident on the user interface 710 therefore operate on the Internet service, by controlling at least a portion of DNS resolutions via a dynamic policy engine 730, before the service reaches the displays of the user devices 650.

The user interface 710 provides the users 660 with access to one or more policy applications 720. The user interface 710 may provide access to a selection list to at least one authorized user 660. The authorized user 660 uses the selection list or some other menu mechanism to select those policy applications 720 that the user 660 chooses to apply to the system 700. The authorized user 660 may select any number of the available policy applications for use on the system 700 at any given time. In implementations utilizing Smartphones as the user device 650, the policy applications 720 are downloaded to the device 650. The device 650 then serves as the user interface 710 to communicate directly with the dynamic policy engine 730.

The policy applications 720 may prohibit access to specific sites. The policy applications 720 may also limit the time of day when users or selected users 660 may access certain sites. The policy applications 720 may also manage and analyze duration of access to various sites. It is important to note that the policy applications 720 do not simply provide blocking mechanisms by masking or enabling network controls, but rather mediate an Internet service received by the end user. As used herein, mediating the service may include any of blocking, constraining, enabling, redirecting, promoting, demoting, substituting, obscuring, limiting, interrupting, and restricting all or a portion of the Internet service. The policy applications 720 may provide notifications or alerts to one or more users 660 when sites are accessed. The policy applications 720 may also provide notification of frequency and duration of access of designated sites. The policy applications 720 may also be used to observe, substitute, enable, redirect users, to reward behavior desired from the users by a system administrator, etc. The policy applications 720 may redirect users from a non-favored site to another site. The policy applications 720 may also collect and transmit data characteristic of Internet use.

Access policies supplied by the policy applications 720 may apply to all users 660 of the system 700, or the access policies may be specific to individual users or groups of users 660. The policy applications 720 may be discrete, single purpose applications.

The policy applications 720 provide the users 660 with a mechanism to take various actions relative to their Internet service feed. The policy applications 720 also allow the users 660 to establish a dynamic policy engine 730 that includes a user database. The policy engine 730 is used to enforce rules associated with each policy application associated with individual end users, not simply block various inappropriate sites from the Internet feed. Rather, the dynamic policy engine 730, controlled by the user interface 710 through user device(s) 650, is used to manage all aspects of the Internet experience for the users 660. In sum, the policy applications 720 may be used to configure the dynamic policy engine 730 to provide the users 660 with a mechanism to personalize the Internet experience. The policy applications 720 may be configured in combinations, and may each be separately configured.

The database in the policy engine 730 may be used to record and to notify users 660 of various data relative to Internet access. The data collected from and provided to the users 660 may include records of access of specific sites, time spent on specific sites, time of day of access, data specific to individual users, etc.

It should also be noted that following an initial setup through the user interface 710 of the policy engine 730, a direct access 740 enforcement loop may be established between the policy engine 730 and the user devices 650. Subsequent accessing of the DNS network 640 utilizing the direct access 740 decreases response time in the system 700, thereby further enhancing the Internet experience of the users 660. Configurations of policy applications 720 that are selected by one or more users 660 designated as system administrators may remain in the user database of the policy engine 730 until such time as it may be modified by the system administrators. The system administrators may define multiple policy configurations, with a combination of policy applications 720, applicable to one or more end users 660 of the system 700. Each policy application 720 may be separately configurable as well. Policy configurations may vary based upon designated times, conditional triggers, or specific requests from the users 660 with administrative authority.

As indicated above, two discrete data flow paths may be established for the system 700. A first data path establishes a set of enforcement policies for the system 700. The first data path flows from at least one user device 650 through the user interface 710, to the policy enforcement engine 730. A second data path 740 may be utilized following the establishment of a set of policies for the system 700. The second data path 740 flows directly between the user device(s) 650 and the policy engine 730. Multiple sets of enforcement policies may be established and saved within the system 700 and implemented selectively by the users 660.

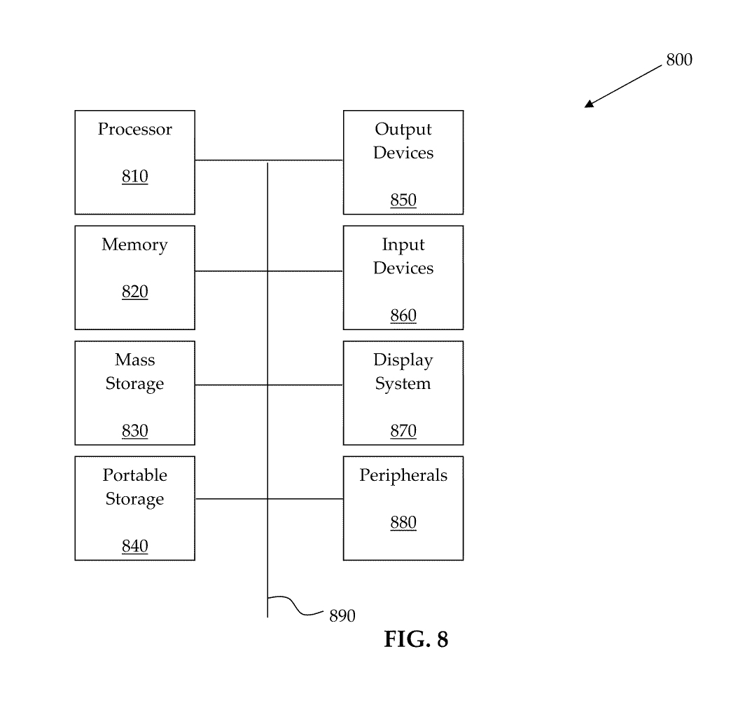

FIG. 8 illustrates an exemplary computing system 800 that may be used to implement an embodiment of the present invention. System 800 of FIG. 8 may be implemented in the context of user devices 650, DNS server 610, Internet cloud 750 and the like. The computing system 800 of FIG. 8 includes one or more processors 810 and memory 820. Main memory 820 stores, in part, instructions and data for execution by processor 810. Main memory 820 can store the executable code when the system 800 is in operation. The system 800 of FIG. 8 may further include a mass storage device 830, portable storage medium drive(s) 840, output devices 850, user input devices 860, a graphics display 840, and other peripheral devices 880.

The components shown in FIG. 8 are depicted as being connected via a single bus 890. The components may be connected through one or more data transport means. Processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing embodiments of the present invention for purposes of loading that software into main memory 810.

Portable storage device 840 operates in conjunction with a portable non-volatile storage medium, such as a floppy disk, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Suitable output devices include speakers, printers, network interfaces, and monitors.

Display system 870 may include a liquid crystal display (LCD) or other suitable display device. Display system 870 receives textual and graphical information, and processes the information for output to the display device.

Peripherals 880 may include any type of computer support device to add additional functionality to the computer system. Peripheral device(s) 880 may include a modem or a router.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” encompasses any content that may be accessed by a user device including but not limited to one or more of web sites, domains, web pages, web addresses, hyperlinks, URLs, any text, pictures, and/or media (such as video, audio, and any combination of audio and video) provided or displayed on a web page, and any combination thereof. A mediation policy may include any of blocking, constraining, enabling, redirecting, promoting, demoting, substituting, obscuring, limiting, interrupting.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method for mediating the delivery of Internet service to at least one user device coupled to the Internet service at a selected location, the method comprising:
receiving information indicative of at least one category of restricted Internet content and including associated Internet content records in a conduct policy; and
applying the conduct policy to the Internet service such that an attempt to access restricted Internet content included in the conduct policy causes the prevention of delivery of the Internet service for a predetermined period of time to all devices in a network coupled to the Internet service.

2. The method of claim 1, further comprising creating at least one Internet content record by:
identifying Internet content;
evaluating the identified Internet content; and
storing the Internet content in a Internet content record according to the content thereof.

3. The method of claim 2, wherein an Internet content record corresponds to a category of restricted Internet content.

4. The method of claim 3, wherein a category of restricted Internet content includes a predefined category.

5. The method of claim 3, wherein categories of restricted Internet content are determined by an administrator.

6. The method of claim 3, wherein categories are created by a group of otherwise unrelated users of the Internet service.

7. The method of claim 1, wherein the conduct policy includes at least one of:
administrator-defined Internet content;
Internet content from at least one Internet content record; and
an administrator-defined period of time.

8. The method of claim 7, wherein the conduct policy is created by:
receiving information indicative of administrator-defined Internet content;
identifying Internet content corresponding to the received information; and
storing the Internet content in a user record.

9. The method of claim 8, wherein receiving information further includes:
receiving information indicative of at least one category of restricted Internet content;
identifying Internet content included in an Internet content record corresponding to the at least one category of restricted Internet content; and
storing the Internet content in the user record.

10. The method of claim 9, wherein creating the conduct policy further includes:
receiving information indicative of an administrator-defined period of time; and
storing the received information indicative of the administrator-defined period of time in the user record.

11. The method of claim 1, wherein a triggering event caused by a first user device coupled to the Internet service prevents the delivery of Internet content to all user devices in a network including the first user device and being coupled to the Internet service, for a period of time.

12. The method of claim 11, wherein the period of time Internet content delivery is blocked is set by an administrator and depends on the type of Internet content accessed.

13. The method of claim 11, wherein Internet content delivery is blocked until an administrator allows access to the Internet content.

14. The method of claim 1, wherein the predetermined period of time is established by a preconfigured default period.

15. The method of claim 1, wherein preventing the delivery includes blocking all resolutions performed by the Internet service for the predetermined period of time.

16. The method of claim 1, wherein preventing the delivery includes preventing the delivery of Internet content to an Internet connection device coupled to the Internet service, for the predetermined period of time.

17. The method of claim 1, wherein preventing the delivery includes blocking all resolutions performed by an Internet service provider for the predetermined period of time.

18. The method of claim 1, wherein during the predetermined period of time the method includes outputting notification to a user device coupled to the Internet service that delivery of the Internet service has been prevented.

19. The method of claim 18, wherein a history of all notifications are stored and are accessible for processing, analysis, or reporting.

20. The method of claim 18, wherein notification is delivered via email.

21. The method of claim 1, wherein the Internet content includes any of a domain, a video, audio, and an application.

22. The method of claim 1, wherein the administrator specifies different mediation policies for different locations.

23. The method of claim 1, wherein when Internet delivery is prevented, selected sites are allowed access.

24. The method of claim 23, wherein the selected sites include sites providing voice communication.

25. The method of claim 1, wherein all users on the network are notified of the identity of the end user whose attempt to access the restricted Internet content caused prevention of delivery of the Internet service.

26. The method of claim 1, wherein an administrator may establish customized conduct policies for individual end users or groups of end users.

27. The method of claim 1, wherein at least one element of the mediation policy is resident on the DNS server.

28. The method of claim 1, wherein at least one element of the mediation policy is enforced by the DNS server.

29. The method of claim 1, wherein at least a portion of the Internet service resides on a user device.

30. A system for mediating the delivery of Internet service at a selected location to at least one user device, the system comprising:
a memory for storing a program;
a processor for executing the program;
a conduct policy module stored in the memory and executable by the processor to receive information indicative at least one category of restricted Internet content and including associated Internet content records in a conduct policy; and
a policy application engine stored in the memory and executable by the processor to apply a conduct policy to the Internet service such that an attempt to access restricted Internet content included in the conduct policy causes the prevention of delivery of the Internet service for a predetermined period of time to all devices in a network coupled to the Internet service.

31. The system of claim 30, further comprising a gathering module stored in the memory and executable by the processor to create at least one Internet content record by:
identifying Internet content;
evaluating the identified Internet content; and
storing the Internet content in a Internet content record according to the content thereof.

32. The system of claim 30, wherein an Internet content record corresponds to a category of restricted Internet content.

33. The system of claim 30, wherein the conduct policy module creates a conduct policy by:
locating Internet content corresponding to the information received by the conduct policy module; and
combining the Internet content with the administrator-defined period of time in the user record.

34. The system of claim 30, wherein the predetermined period of time includes a default period of time equal to one hour.

35. The system of claim 30, wherein preventing the delivery includes blocking all resolutions performed by the Internet service for the predetermined period of time.

36. The system of claim 30, wherein preventing the delivery includes preventing the delivery of Internet service to an Internet connection device coupled to the Internet service for the predetermined period of time.

37. The system of claim 30, wherein preventing the delivery includes blocking all resolutions performed by an Internet service provider for the predetermined period of time.

38. The system of claim 30, further comprising a user interface module stored in the memory and executable by the processor to output notification to a user device coupled to the Internet service that delivery of the Internet service has been prevented, during the predetermined period of time after the occurrence of a triggering event.

39. The system of claim 30, wherein at least one element of the mediation policy is resident on the DNS server.

40. The system of claim 30, wherein at least one element of the mediation policy is enforced by the DNS server.

41. The system of claim 30, wherein the administrator uses different mediation policies for different locations.

42. The system of claim 30, wherein at least a portion of the Internet service resides on a user device.

43. The system of claim 38, wherein a history of all notifications are stored and are accessible, for processing, logging and analysis.

44. A computer readable storage medium having a program embodied thereon, the program executable by a processor in a computing device to perform a method of mediating Internet service delivered at a particular location to at least one user device, the method comprising:
executing instructions stored in a memory by a processor to prevent the delivery of Internet service to the at least one user device for a predetermined period of time after an occurrence of a triggering event.

45. A method for mediating the delivery of Internet service to at least one user device coupled to the Internet service at a selected location, the method comprising:
receiving at a DNS server information indicative of at least one category of restricted Internet content and including associated Internet content records in a conduct policy; and
applying the conduct policy to the Internet service via the DNS server such that an attempt to access restricted Internet content included in the conduct policy causes the prevention of delivery of the Internet service for a predetermined period of time to all devices in a network coupled to the Internet service.

46. The method of claim 45, further comprising creating at least one Internet content record in the DNS server by:
identifying Internet content;
evaluating the identified Internet content; and
storing the Internet content in a Internet content record according to the content thereof.

47. The method of claim 46, wherein an Internet content record stored in the DNS server corresponds to a category of restricted Internet content.

48. The method of claim 47, wherein a category of restricted Internet content records includes a predefined category.

49. The method of claim 47, wherein categories of restricted Internet content records are determined by an administrator.

50. The method of claim 47, wherein categories and content records are created by a group of otherwise unrelated users of the Internet service.

51. The method of claim 47, wherein the conduct policy stored in the DNS server includes at least one of:
administrator-defined Internet content;
Internet content from at least one Internet content record; and
an administrator-defined period of time.

52. The method of claim 51, wherein the conduct policy stored in the DNS server is created by:
receiving information indicative of administrator-defined Internet content;
identifying Internet content records corresponding to the received information; and
storing the Internet content records in the DNS server.

53. The method of claim 52, wherein receiving information further includes:
receiving information indicative of at least one category of restricted Internet content;
identifying Internet content included in an Internet content record corresponding to the at least one category of restricted Internet content; and
storing the Internet content records in the DNS server.

54. The method of claim 53, wherein creating the conduct policy stored in the DNS server further includes:
receiving information indicative of an administrator-defined period of time; and
storing the received information indicative of the administrator-defined period of time in the user record.

55. The method of claim 46, wherein the DNS server receives a request for the restricted Internet content record that is part of the Internet conduct policy by a first user device coupled to the Internet service causing a triggering that prevents the delivery of Internet content to all user devices in a network including the first user device and being coupled to the Internet service, for a period of time.

56. The method of claim 55, wherein the period of time Internet content delivery is blocked by the DNS server is set by an administrator and depends on the type of Internet content accessed.

57. The method of claim 55, wherein Internet content delivery is blocked until an administrator allows access to the Internet content.

58. The method of claim 45, wherein the predetermined period of time is established by a preconfigured default period.

59. The method of claim 45, wherein the administrator specifies different mediation polices for different locations.

60. The method of claim 45, wherein preventing the delivery includes blocking resolutions to Internet content records performed by the DNS server for the predetermined period of time.

61. The method of claim 45, wherein preventing the delivery includes preventing the delivery of Internet content to any Internet device coupled to the Internet service, for the predetermined period of time.

62. The method of claim 45, wherein preventing the delivery includes blocking resolutions to all Internet content records performed by a DNS server provided by an Internet service provider for the predetermined period of time.

63. The method of claim 45, wherein during the predetermined period of time the method includes outputting notification to a user device coupled to the Internet service that delivery of the Internet service has been prevented.

64. The method of claim 45, further comprising recording a history of all requests to access restricted Internet content, the history being stored and accessible for processing, analysis, or reporting.

65. The method of claim 64, wherein notification is delivered to users of the network via email.

66. The method of claim 45, wherein when Internet delivery is prevented, access to selected Internet content is allowed.

67. The method of claim 66, wherein the allowed Internet content includes voice communication.

68. The method of claim 45, wherein all users on the network are notified of the identity of the end user whose attempt to access the restricted Internet content records in the DNS server caused prevention of delivery of the Internet service.

69. The method of claim 45, wherein an administrator may establish customized conduct policies in the DNS server for individual end users or groups of end users.

70. The method of claim 45 wherein the Internet service identifies the Internet content record in the DNS server based on the category of Internet content.

71. The method of claim 45, wherein at least a portion of the Internet Service resides on a user device.

72. A system for mediating the delivery of Internet service at a selected location to at least one user device, the system comprising:
a memory for storing a program;
a processor for executing the program;
a conduct policy module stored in the memory and executable by the processor to receive information via a DNS server indicative at least one category of restricted Internet content and including that information in a conduct policy; and
a policy application engine stored in the memory and executable by the processor to apply a conduct policy to the Internet service via a DNS server such that an attempt to access restricted Internet content included in the conduct policy causes the prevention of delivery of the Internet service for a predetermined period of time to all devices in a network coupled to the Internet service.

73. The system of claim 72, further comprising a gathering module stored in the memory and executable by the processor to create at least one Internet content record by:
identifying Internet content;
evaluating the identified Internet content; and
storing the Internet content in a Internet content record according to the content thereof.

74. The system of claim 72, wherein an Internet content record corresponds to a category of restricted Internet content.

75. The system of claim 72, wherein the conduct policy module creates a conduct policy by:
locating Internet content corresponding to the information received by the conduct policy module; and
combining the Internet content with the administrator-defined period of time in the user record.

76. The system of claim 72, wherein the predetermined period of time includes a default period of time equal to one hour.

77. The system of claim 72, wherein the administrator uses different mediation policies for different locations.

78. The system of claim 72, wherein preventing the delivery includes blocking all resolutions performed by the Internet service for the predetermined period of time.

79. The system of claim 72, wherein preventing the delivery includes preventing the delivery of Internet service to an Internet connection device coupled to the Internet service for the predetermined period of time.

80. The system of claim 72, wherein preventing the delivery includes blocking all resolutions performed by an Internet service provider for the predetermined period of time.

81. The system of claim 72, further comprising a user interface module stored in the memory and executable by the processor to output notification to a user device coupled to the Internet service that delivery of the Internet service has been prevented, during the predetermined period of time after the occurrence of a triggering event.

82. The system of claim 72, wherein at least a portion of the Internet Service resides on a user device.
